(19) United States
(12) Patent Application Publication
(10) Pub. No.: US 2026/0170965 A1
(43) Pub. Date: Jun. 18, 2026

(54) SYSTEMS AND METHODS FOR DETERMINNG A FLIGHT PLAN FOR AN AIRCRAFT

(71) Applicant: THE BOEING COMPANY, Arlington, VA (US)

(72) Inventors: Lucas Cardoso Navarro, Sao Jose dos Campos (BR); José Alexandre Tavares Guerreiro Fregnani, Sao Jose dos Campos (BR); Johan De Prins, Molenstede (BE); Salvador Ramirez Blanco, Madrid (ES); Maxim Constantijn Vos, Móstoles (ES); Geun Kim, Bothell, WA (US)

(73) Assignee: THE BOEING COMPANY, Arlington, VA (US)

(21) Appl. No.: 18/979,960

(22) Filed: Dec. 13, 2024

(51) Int. Cl. G08G 5/34; G08G 5/76

(52) U.S. Cl. CPC G08G 5/34; G08G 5/76

(57) ABSTRACT

A system and a method included a control unit configured to receive wind characteristics for locations at and between a current location of an aircraft and an arrival location, and revise a flight plan at one or more of the locations based on the wind characteristics to provide a revised flight plan. The aircraft is configured to be operated to fly from the current location to the arrival location according to the revised flight plan.

### FIELD OF THE DISCLOSURE

Examples of the present disclosure generally relate to systems and methods for determining a flight plan for an aircraft, such as a flight plan that reduces fuel consumption of the aircraft.

### BACKGROUND OF THE DISCLOSURE

Aircraft are used to transport passengers and cargo between various locations. Numerous aircraft depart from and arrive at a typical airport every day.

Certain airspaces around the world (such as in the South Atlantic, Indian Ocean, and Pacific Ocean) allow aircraft to fly along various lateral paths between specific entry and exit gates at particular borders within such airspaces. In these regions, flight planning systems commonly optimize a trajectory for an aircraft by plotting a great circle route between a selection of entry and exit waypoints.

Headwinds can affect fuel consumption during a flight, such as along the great circle route. For example, an aircraft flying directly into a headwind consumes a greater amount of fuel than an aircraft that is not flying into the headwind.

### SUMMARY OF THE DISCLOSURE

A need exists for a system and a method for determining a flight plan for an aircraft that minimizes or otherwise reduces fuel consumption. Further, a need exists for a system and a method for determining a flight plan that minimizes or otherwise reduces flight time in headwinds.

With those needs in mind, certain examples of the present disclosure provide a system including a control unit configured to receive wind characteristics for locations at and between a current location of an aircraft and an arrival location, and revise a flight plan at one or more of the locations based on the wind characteristics to provide a revised flight plan. The aircraft is configured to be operated to fly from the current location to the arrival location according to the revised flight plan.

The wind characteristics include wind direction and wind speed (such as at a given altitude).

The control unit can be onboard the aircraft.

The system can also include a user interface including a display. The control unit is in communication with the user interface. The control unit is further configured to show the revised flight plan on the display.

The control unit can be further configured to automatically control the aircraft according to the revised flight plan.

The wind conditions can include current and forecasted wind conditions (such as at a given altitude).

In at least one example, the control unit is further configured to determine a corridor along the flight plan, to generate a grid including nodes within the corridor, determine costs between different nodes, and calculate a shortest path having a lowest cost. The shortest path having the lowest cost can be the revised flight plan.

Certain examples of the present disclosure provide a method including: receiving, by a control unit, wind characteristics for locations at and between a current location of an aircraft and an arrival location; revising, by the control unit, a flight plan at one or more of the locations based on the wind characteristics to provide a revised flight plan; and operating the aircraft to fly from the current location to the arrival location according to the revised flight plan.

### BRIEF DESCRIPTION OF THE DRAWINGS

FIG. 1 illustrates a block diagram of a system, according to an example of the present disclosure.

FIG. 2 illustrates a front view of a display, according to an example of the present disclosure.

FIG. 3 illustrates a front view of a display, according to an example of the present disclosure.

FIG. 4 illustrates a simplified view of an aircraft at a departure location, according to an example of the present disclosure.

FIG. 5 illustrates a simplified view of possible flight paths within a grid for an aircraft, according to an example of the present disclosure.

FIG. 6 illustrates a simplified view of a revised flight plan, according to an example of the present disclosure.

FIG. 7 illustrates a front view of a display, according to an example of the present disclosure.

FIG. 8 illustrates a flow chart of a method, according to an example of the present disclosure.

FIG. 9 illustrates a schematic block diagram of a control unit, according to an example of the present disclosure.

FIG. 10 illustrates a perspective front view of an aircraft, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

Examples of the present disclosure provide a system and a method that reduce overall fuel consumption for an aircraft during flight between a departure location and arrival location. The systems and methods include a control unit configured to adjust a flight path within a specific range of angles along a route, effectively minimizing or otherwise reducing the impact of direct wind components at a given altitude. By deviating from a traditional direct route between origin and destination waypoints, for example, the systems and methods allow for a significant reduction in direct operational costs (such as with respect to time and fuel consumption).

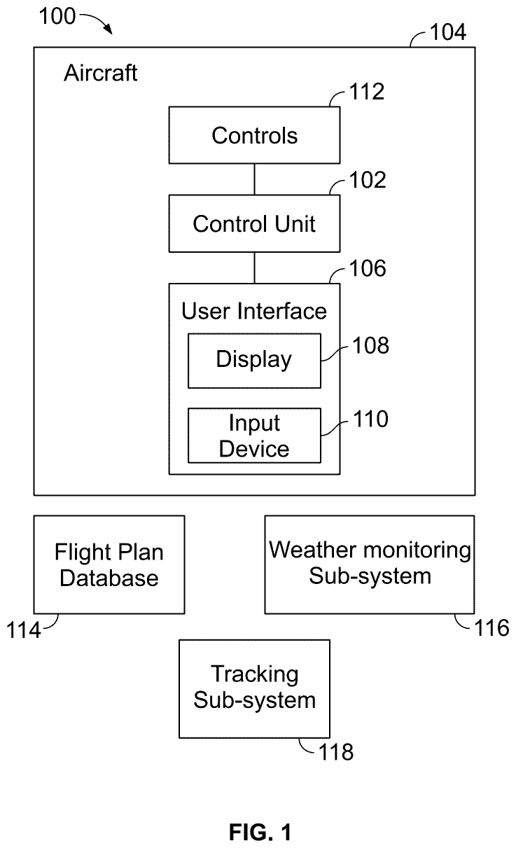

FIG. 1 illustrates a block diagram of a system 100, according to an example of the present disclosure. The system 100 includes a control unit 102, such as onboard an aircraft 104. In at least one example, the control unit 102 is or otherwise include a flight management computer. Optionally, the control unit 102 can be remote from the aircraft 104, such as at a monitoring location, which can be land-based, and in communication with the aircraft 104 through a communication device, such as one or more antennas, one or more transceivers, one or more radios, and/or the like.

The control unit 102 is in communication with a user interface 106 onboard the aircraft 104. The user interface 106 can be part of a computer workstation, such as within a cockpit or flight deck of the aircraft 104. As an example, the flight management computer can include the user interface 106. The flight management computer typically receives data regarding a flight plan between a departure airport and an arrival or destination airport, for example. The flight management computer can be used to control aspects of the aircraft 104. For example, the flight management computer can be used to automatically control operation of the aircraft 104. As another example, the user interface 106 is a handheld device, such as a smartphone, smart tablet, or the like. Optionally, examples of the present disclosure may not include a user interface, such as in an unmanned aircraft.

The user interface 106 includes a display 108 and an input device 110. The user interface 106 can be used by a pilot to monitor operations, control operations, review information, and/or the like. In at least one example, the display 108 is an electronic monitor, screen, and/or the like, and the input device 110 includes one or more of a keyboard, a mouse, a stylus, and/or the like. In at least one example, the display 108 and the input device 110 are integrated as a touchscreen interface.

The aircraft 104 includes controls 112, which are used to control operation of the aircraft 104. Examples of the controls 112 include a steering console, a yoke, a joystick, one or more brakes, buttons, dials, keys, levers, buttons or pedals, and/or the like. In at least one example, the control unit 102 is in communication with the controls 112, such as through one or more wired or wireless connections.

The control unit 102 is in communication with a flight plan database 114, such as through one or more wired or wireless connections. In at least one example, the flight plan database 114 is onboard the aircraft 104. As another example, the flight plan database 114 is remote from the aircraft, such as at flight planning operations center. The flight plan database 114 stores electronic data regarding a flight plan for the aircraft 104. The flight plan for the aircraft 104 includes a route from a departure location (such as a first airport), and an arrival location (such as a second airport or a waypoint between the first airport and the second airport). In at least one example, the route includes waypoints between the departure location and the arrival location. The flight plan includes a latitude and longitude for the departure location and the arrival location, as well as various nodes therebetween (such as the waypoints). In at least one example, the flight plan is a lateral flight path, which includes latitude and longitude positions. In at least one example, the flight plan further includes altitudes at various locations between the departure location and the arrival location.

The control unit 102 is further in communication with a weather monitoring sub-system 116, such as through wireless connection(s). As an example, the weather monitoring sub-system 116 is a weather detection and forecasting service, which detects and forecasts weather conditions (such as temperature, precipitation, wind speeds and directions, and the like) at various locations around the world. In at least one example, the control unit 102 receives wireless communications from the weather monitoring subsystem 116 that include information regarding weather conditions at various locations between and including the departure location and the arrival location.

In at least one example, the control unit 102 is also in communication with a tracking sub-system 118, which tracks the aircraft 104 within an airspace. In at least one example, the tracking sub-system 118 is configured to track positions of the aircraft 104 in real time. In at least one example, the tracking sub-system 118 is a radar sub-system. As another example, the tracking sub-system 118 is an automatic dependent surveillance-broadcast (ADS-B) tracking sub-system. Real time positions of the aircraft 104 on the ground and within the airspace are detected by the tracking sub-system 118 that receives position signals output by a position sensor of the aircraft 104. For example, the tracking sub-system 118 receives ADS-B signals output by the position sensor(s) of the aircraft 104. As another example, the position sensor(s) of the aircraft 104 can be global positioning system sensors. The position sensor(s) outputs signals indicative of one or more of the position, altitude, heading, acceleration, velocity, and/or the like of the aircraft 104. The signals are received by the tracking sub-system 118. The control unit 102 receives the tracking information of the aircraft 104, such as from signals output by the tracking subsystem 118.

In operation, the control unit 102 receives an initial flight plan for the aircraft 104. The initial flight plan includes a flight path or route from the departure location to the arrival location, and waypoints therebetween. In at least one example, the control unit 102 receives an electronic signal from the flight plan database 114. The electronic signal includes data regarding the initial flight plan. The control unit 102 can electronically show the initial flight plan on the display 108 of the user interface 106.

The weather monitoring sub-system 116 outputs weather data including wind characteristics (such as wind directions and wind speeds) for various locations at and between the departure location and the arrival location. The control unit 102 receives the weather data from the weather monitoring sub-system 116. The control unit 102 determines wind directions and wind speeds (such as current actual, real time wind directions and wind speeds, and forecasted future wind directions and wind speeds) for locations (such as latitude, longitude, and altitude) along the initial flight plan. Based on the wind directions and wind speeds, the control unit 102 revises the initial flight plan to provide a revised initial flight plan based on wind characteristics (for example, wind direction and wind speed) at locations along the flight plan. For example, in order to reduce fuel consumption of the aircraft 104 during a flight between the departure location and the arrival location, the control unit 102 revises the flight plan at one or more locations to reduce an impact of headwinds on the aircraft. In particular, the control unit 102 revises a heading of the aircraft 104 at the one or more locations so that the aircraft 104 does not experience a direct headwind. In at least one example, the control unit 102 revises the flight plan for the aircraft 104 before a flight between the departure location and the arrival location based on the wind characteristics at the locations along the flight plan. In at least one further example, the control unit 102 revises the flight plan as the aircraft is flying according to the flight plan. For example, the tracking sub-system 118 tracks the position of the aircraft 104 between the departure location and the arrival location. The control unit 102 receives wind characteristics from the weather monitoring sub-system 116 for a current location of the aircraft 104 within the airspace to the departure location. The control unit 102 then revises the flight plan of the aircraft 104 in-flight.

In at least one example, the control unit 102 revises or otherwise adjusts the flight plan (for example, a lateral flight path) within a specific range of heading change angles along a route, effectively minimizing or otherwise reducing the impact of direct wind components at a given location within the airspace. In at least one example, by deviating from a traditional direct, great circle route between two different waypoints, the control unit 102 is able to determine a revised flight plan that reduces the amount of fuel consumed by the aircraft during a flight.

In at least one example, the weather data output by the weather monitoring sub-system 116 (and received by the control unit 102) includes wind data and temperature data. In at least one example, the weather data includes three-dimensional (3D) actual and predicted wind characteristics (for example, wind direction and wind speed) for locations along the flight plan. In at least one example, the weather data includes actual measured wind speed and direction at a current position of the aircraft 104, as well as predicted wind speeds and directions at locations ahead of the aircraft 104. The control unit 102 determines the wind characteristics along the flight plan from the weather data received from the weather monitoring sub-system 116 and revises the flight plan at one or more locations based on the wind characteristics in order to minimize or reduce headwind components experienced by the aircraft 104 during a flight to the arrival location.

In at least one example, the control unit 102 can provide a fuel consumption reduction option on the display 108 of the user interface 106. For example, the control unit 102 provides a prompt on the display 108, which can be selected by an operator of the aircraft 104. In response to selecting the fuel consumption reduction option, the control unit 102 then revises a flight plan, such as received from the flight plan database 114, to reduce headwind components (such as determined from wind characteristics received from the weather monitoring sub-system 116) at locations along the flight plan. In at least one example, the control unit 102 determines a corridor of approximately +/−100-250 nautical miles for each side of a great circle route from a first location to a second location. The control unit 102 can then determine that heading changes at various locations along the flight plan are allowed within a predetermined angular difference (such as +/−20-45 degree, for example) from the locations along the flight plan. In at least one example, an operator of the aircraft uses the input device 110 of the user interface 106 to select entry and exit waypoints for locations that are ahead of a current position of the aircraft 104 (such as tracked by the tracking sub-system 118) in the flight plan. The control unit 102 can continually determine wind characteristics for the locations along the flight plan, and subsequently revise the flight plan based on the wind characteristics, or can periodically determine the wind characteristics and revise the flight plan, such as every 15, 20, 30, or more minutes. The control unit 102 shows the modified flight plan on the display 108 of the user interface 106. The aircraft 104 is flown according to the modified flight plan to the arrival location.

In at least one example, the aircraft 104 is automatically operated according to the modified flight plan. For example, the control unit 102 can automatically operate one or more of the controls 112 (without human intervention) according to the modified flight plan.

As described herein, the system 100 includes the control unit 102, which is configured to receive wind characteristics for locations at and between a current location (such as departure airport, a current location during flight, or the like) of the aircraft 104 and an arrival location (such as a waypoint at a further location from the current location, an arrival airport, or the like). The control unit 102 is further configured to revise a flight plan at one or more of the locations based on the wind characteristics to provide a revised flight plan. The aircraft 104 is then operated to fly from the current location to the arrival location according to the revised flight plan.

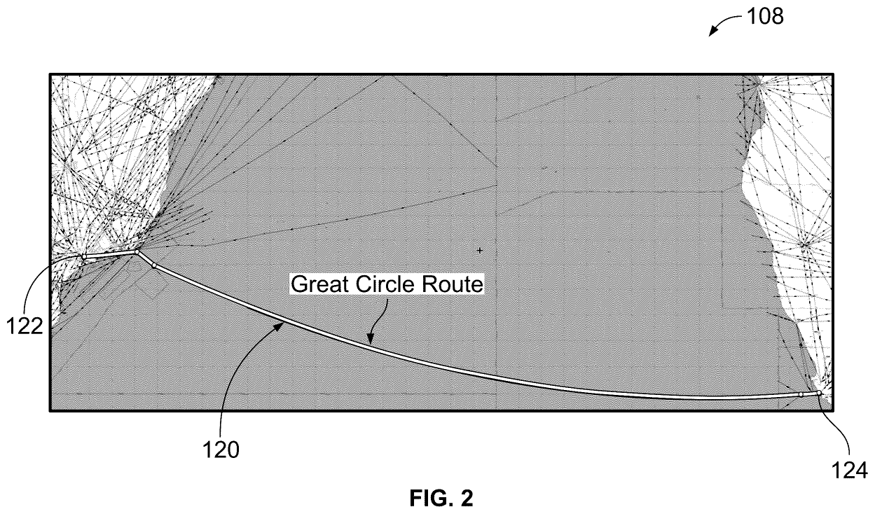

FIG. 2 illustrates a front view of the display 108, according to an example of the present disclosure. Referring to FIGS. 1 and 2, the control unit 102 shows a flight plan 120 on the display 108. The flight plan 120 includes a path from a departure location 122, such as a first airport, and an arrival location 124, such as a second airport. As shown, the flight plan 120 can be for a long haul, trans-oceanic flight, and can be initially provided as a great circle route.

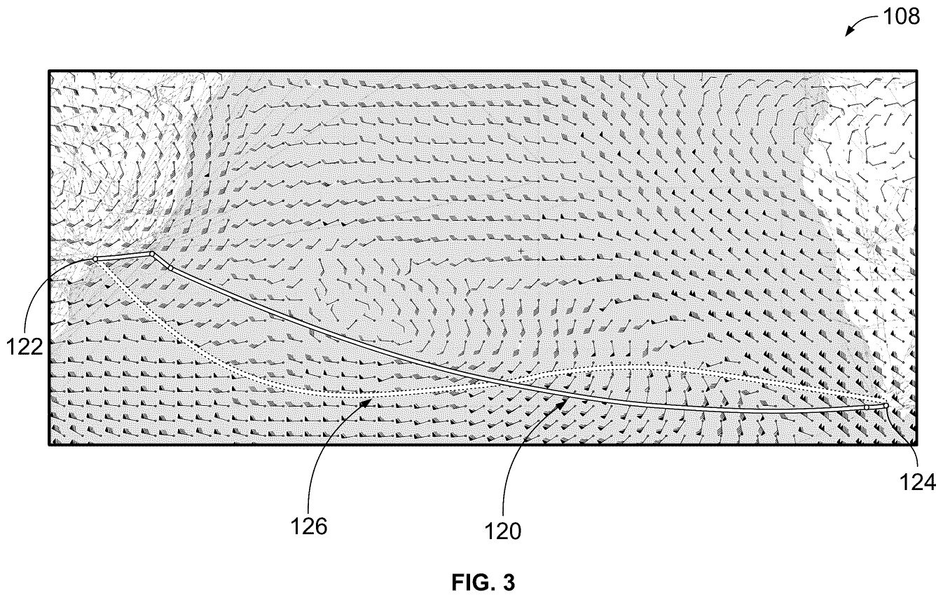

FIG. 3 illustrates a front view of the display 108, according to an example of the present disclosure. Referring to FIGS. 1-3, the control unit 102 receives weather data from the weather monitoring sub-system 116. The weather data includes wind characteristics (such as wind direction and wind speeds, such as can be shown by arrows at different orientations and highlights), which may or may not be shown on the display 108. Based on the wind characteristics, the control unit 102 revises the flight plan 120 to provide a revised flight plan 126, which minimizes or otherwise reduces direct headwind effects on the aircraft 104 during a flight. The control unit 102 can show both the flight plan 120 and the revised flight plan 126 on the display 108. The control unit 102 can update the flight plan 120 or the revised flight plan 126 during the flight of the aircraft 104 to the arrival location 124.

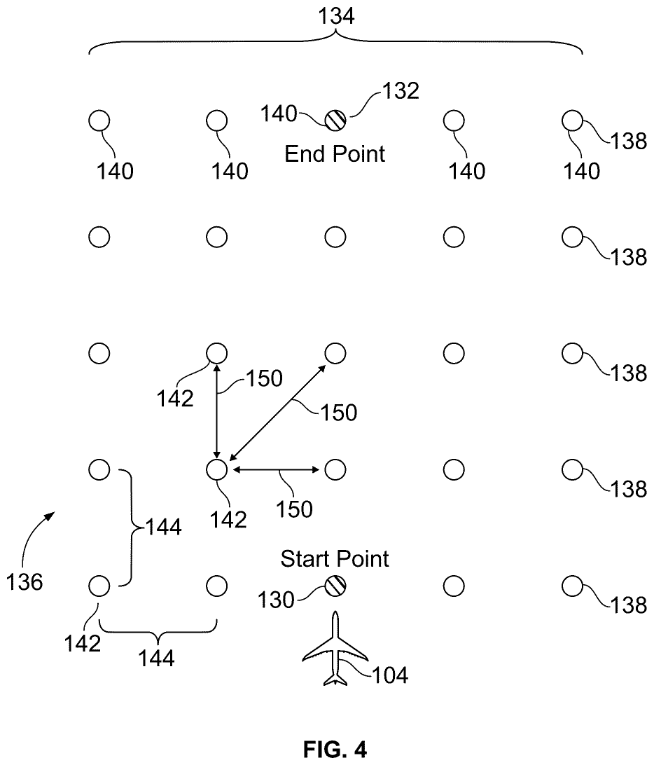

FIG. 4 illustrates a simplified view of the aircraft 104 at a departure location 130, according to an example of the present disclosure. The departure location 130 is a start node, and an arrival location 132 is an end node. Referring to FIGS. 1 and 4, a flight plan is initially determined. The flight plan is from the departure location 130 to the arrival location 132. The flight plan can be initially received by the control unit 102 from the flight plan database 114.

In response to receiving the flight plan, the control unit 102 determines a corridor 134 along the flight plan. The corridor 134 is a lateral width along both sides of the flight plan. For example, the corridor 134 can be 100-500 miles to each lateral side of the flight plan along an entire length of the flight plan. The control unit 102 then generates a grid 136 along the flight plan. The grid 136 includes nodes representative of locations within the corridor 134. The grid 136 includes rows 138 and columns 140. nodes 142 within the grid 136 are locations within an airspace. The control unit 102 spaces the nodes 142 apart from one another, such that neighboring nodes 142 are a predetermined distance 144 from one another, such as 25, 50, 100, 150, 200 miles from one another. The grid 136 shown on FIG. 4 is an example, and not limiting. The grid 136 can include fewer or more nodes 142 than shown, depending on the distance between points 130 and 132.

After determining the grid 136, the control unit 102 then determines latitude and longitude for each node 142 (including the departure location 130 and the arrival location 132) within the grid 136. The control unit 102 can receive the latitude and longitude for the nodes 142 from a global positioning system, a map database, and/or the like. In at least one example, the latitude and longitude for each node can be calculated (such as by the control unit 102) based on a start point. Such data can be used to calculate positions of adjacent nodes until an end point.

Next, the control unit 102 receives weather information for each of the nodes 142 within the grid 136, such as from the weather monitoring sub-system 116. The weather information includes wind characteristics for each node 142 within the grid 136. Thus, the control unit 102 is aware of current and/or predicted wind directions and wind speeds for each node 142 within the grid 136.

Additionally, the control unit 102 determines distances for each node 142 in relation to one or more other nodes 142. In at least one example, the control unit 102 determines a distance from one node 142 in a first row 138 to all nodes 142 in a row 138 immediately downstream (for example, the next row above) the one node 142.

The control unit 102 can then determine costs (based on wind characteristics at the various nodes 142, fuel consumption and/or time to different nodes 142 due to the wind characteristics, and/or precited weight of the aircraft 104 at one or more nodes) for distances from nodes 142 to other nodes 142 within the grid 136. Based on the determined costs, the control unit 102 then calculates a shortest path from a current location of the aircraft 104 to the arrival location 132 between nodes 142 of the grid 136. In at least one example, the control unit 102 uses Dijkstra's algorithm to determine the shortest path.

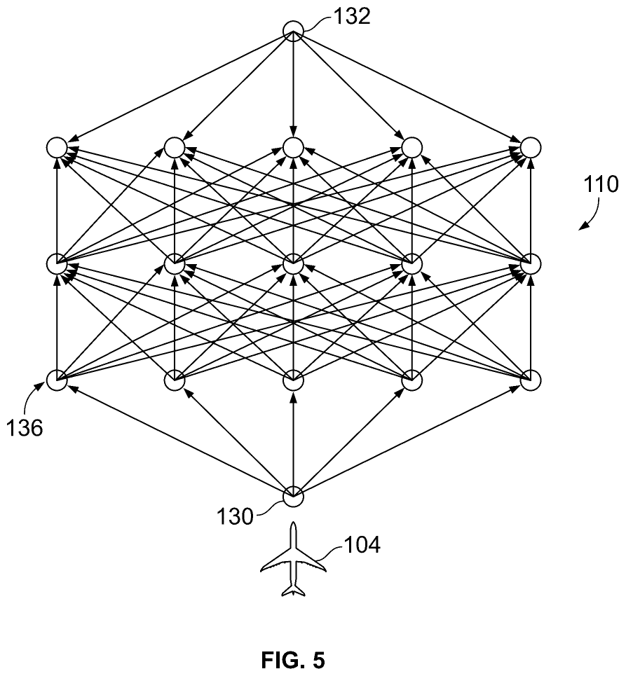

FIG. 5 illustrates a simplified view of possible flight paths within a grid for an aircraft, according to an example of the present disclosure. Referring to FIGS. 1 and 5, in at least one example, the control unit 102 determines all possible flight paths that the aircraft 104 can fly from a current location of the aircraft 104 (such as at the departure location 130) to the arrival location 132 within the grid 136. The control unit 102 then calculates one or more costs (such as fuel costs and/or time costs) for each of the flight paths. The control unit 102 uses the determined wind characteristics to determine such costs, as the winds affect performance of the aircraft 104. For example, flying into a headwind will consume more fuel and potentially increase flying time, in contrast to flying with a tailwind. In at least one example, the control unit 102 uses Dijkstra's algorithm to calculate the shortest path for the aircraft 104 to fly based on an overall cost for such path. In particular, the control unit 102 uses Dijkstra's algorithm to determine the path having the lowest cost, and establishes such path as the revised flight plan.

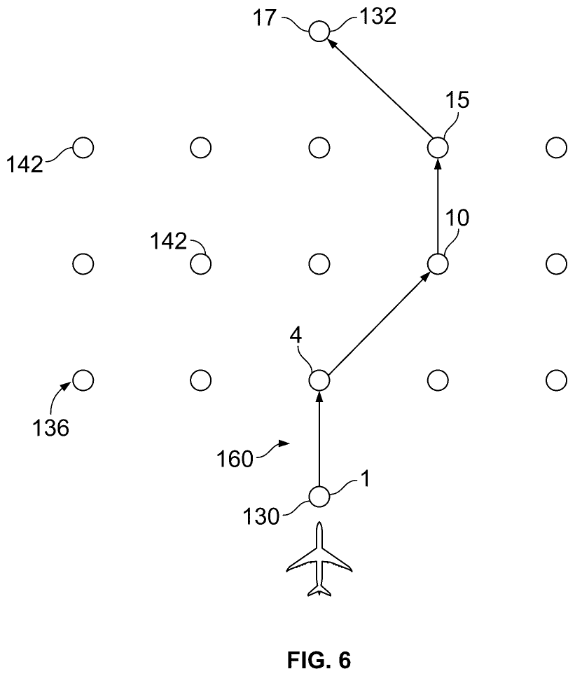

FIG. 6 illustrates a simplified view of a revised flight plan 160, according to an example of the present disclosure. Referring to FIGS. 1 and 6, based on determined wind speeds at the various locations denoted by the nodes 142 within the grid 136, the control unit 102 determines the revised flight plan 160, such as by using Dijkstra's algorithm, to provide the revised flight plan 160 having the lowest fuel costs (optionally, and/or the lowest time cost) as a path extending along nodes 1-4-10-15-17, with node 1 being the current location of the aircraft 104 (such as at the departure location), and node 17 being the arrival location 132. The nodes 1, 4, 10, 15, and 17 are nodes or waypoints, and the path 1-4-10-15-17, which is the revised flight plan 160, is the path the aircraft 104 is to fly in order to reduce fuel cost and/or time cost. As noted, the control unit 102 can then automatically operate the aircraft 104 to fly according to the revised flight plan 160.

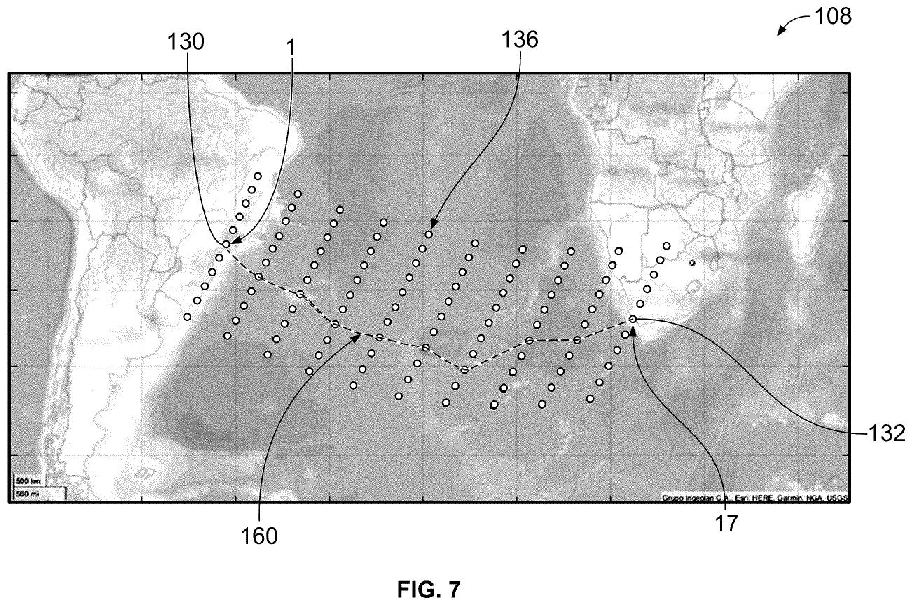

FIG. 7 illustrates a front view of the display 108, according to an example of the present disclosure. Referring to FIGS. 1 and 7, the control unit 102 can show the revised flight plan 160 on the display 108. The control unit 102 can also show the grid 136, which is based on an original flight plan (such as a great circle route), on the display 108.

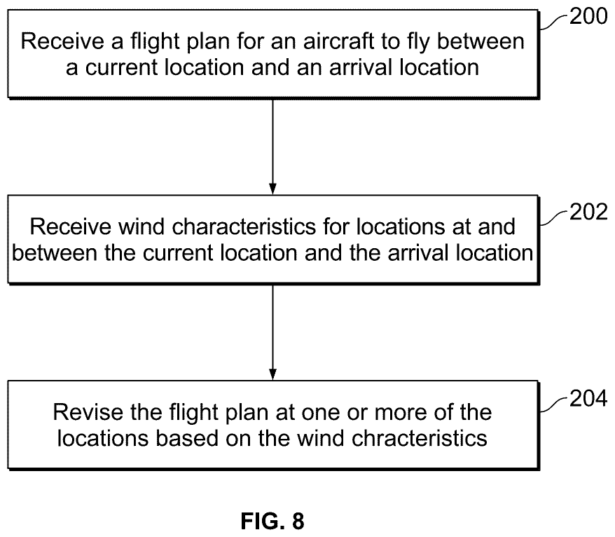

FIG. 8 illustrates a flow chart of a method, according to an example of the present disclosure. Referring to FIGS. 1 and 8, at 200, the control unit 102 receives a flight plan (such as from the flight plan database 114) for the aircraft to fly between a current location (such as at a departure location or currently within an airspace) and an arrival location. At 202, the control unit 102 receives wind characteristics (such as wind directions and wind speeds) for locations at and between the current location and the arrival location. At 204, the control unit 102 then revises the flight plan at one or more of the locations based on the wind characteristics, such as to reduce costs associated within one or both of fuel consumption and/or time of flight. The aircraft 104 is then controlled to fly according to the revised flight plan.

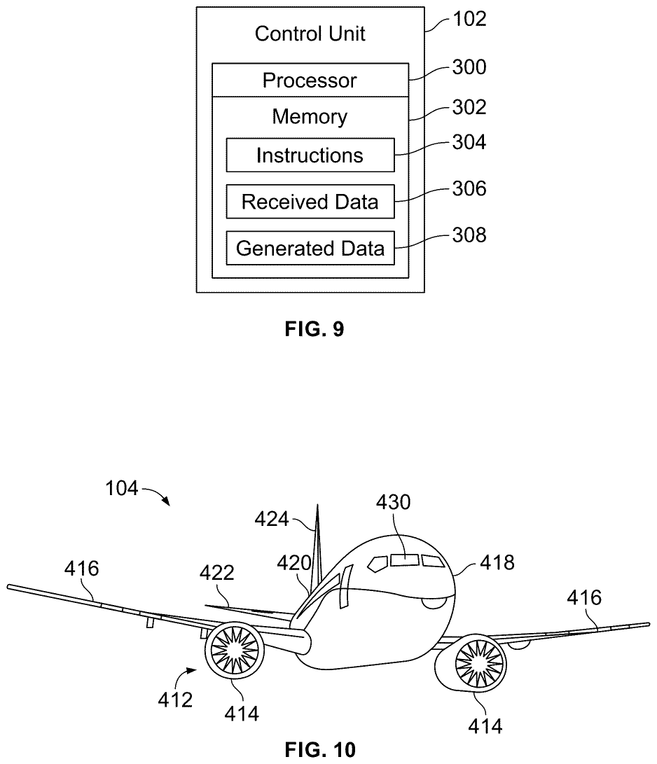

FIG. 9 illustrates a schematic block diagram of the control unit 102, according to an example of the present disclosure. In at least one example, the control unit 102 includes at least one processor 300 in communication with a memory 302. The memory 302 stores instructions 304, received data 306, and generated data 308. The control unit 102 shown in FIG. 9 is merely exemplary, and non-limiting.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 102 may be or include one or more processors that are configured to control operation, as described herein.

The control unit 102 is configured to execute a set of instructions that are stored in one or more data storage units or elements (such as one or more memories), in order to process data. For example, the control unit 102 may include or be coupled to one or more memories. The data storage units may also store data or other information as desired or needed. The data storage units may be in the form of an information source or a physical memory element within a processing machine.

The set of instructions may include various commands that instruct the control unit 102 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the control unit 102. It is to be understood that the processing or control units may represent circuits, circuitry, or portions thereof that may be implemented as hardware with associated instructions (e.g., software stored on a tangible and non-transitory computer readable storage medium, such as a computer hard drive, solid state drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 102 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

Referring to FIGS. 1-9, examples of the subject disclosure provide systems and methods that allow large amounts of data to be quickly and efficiently analyzed by a computing device. For example, the control unit 102 can analyze various wind conditions (for example, current and forecasted wind conditions) at locations along different paths for the aircraft 104 to determine fuel and time costs for various the paths. As such, large amounts of data, which may not be discernable by human beings, are being tracked and analyzed. The vast amounts of data are efficiently organized and/or analyzed by the control unit 102, as described herein. The control unit 102 analyzes the data in a relatively short time in order to quickly and efficiently determine flight plans for the aircraft 104. A human being would be incapable of efficiently analyzing such vast amounts of data in such a short time. As such, examples of the present disclosure provide increased and efficient functionality, and vastly superior performance in relation to a human being analyzing the vast amounts of data.

In at least one example, components of the system 100, such as the control unit 102, provide and/or enable a computer system to operate as a special computer system for automatically determining flight plans based on wind characteristics. The control unit 102 improves upon standard computing devices by determining the information in an efficient and effective manner.

In at least one example, all or part of the systems and methods described herein may be or otherwise include an artificial intelligence (AI) or machine-learning system that can automatically perform the operations of the methods also described herein. For example, the control unit 102 can be an artificial intelligence or machine learning system. These types of systems may be trained from outside information and/or self-trained to repeatedly improve the accuracy with how data is analyzed to automatically determine flight plans. Over time, these systems can improve by determining the information with increasing accuracy and speed, thereby significantly reducing the likelihood of any potential errors. For example, the AI or machine-learning systems can learn and determine the performance capabilities of the aircraft 104, and automatically determine flight plans of the aircraft 104 based on wind characteristics at various locations. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), and/or the like. The systems may be trained and re-trained using feedback from one or more prior analyses of the data, ensemble data, and/or other such data. Based on this feedback, the systems may be trained by adjusting one or more parameters, weights, rules, criteria, or the like, used in the analysis of the same. This process can be performed using the data and ensemble data instead of training data, and may be repeated many times to repeatedly improve the determination of optimized flight plans. The training minimizes conflicts and interference by performing an iterative training algorithm, in which the systems are retrained with an updated set of data (for example, data received before, during, and/or after each flight of the aircraft 104) and based on the feedback examined prior to the most recent training of the systems. This provides a robust analysis model that can better determine situational information in a cost effective and efficient manner.

In at least one example, the control unit 102 includes or represents an artificial neural network (ANN) that identifies patterns in the visual representations of data, classifies the patterns (for example, assigns a class to an identified pattern, such as class #1, class #2, and so on) based on the contents of the patterns that are identified, and identifies one or more flight plans (as described herein) based on the classifications. Usage of a specially trained ANN to identify such information in this way provides improvements over traditional manual methods, including more accurate identification of efficient flight plans, and identification of such information much faster and/or at a much more rapid frequency than is possible with humans. The ANN can be realized through software, hardware, or a combination of software and hardware. The structure of the ANN can be a series of layers, with each layer including one or more artificial neurons arranged in one or more neuron arrays. Each of these neurons may include or represent a register, a microprocessor, and at least one input. Each neuron can produce an output, or activation, based on an activation function that uses the outputs of the previous layer and a set of weights as inputs. Each neuron in a neuron array can be connected to another neuron in the same layer or in another layer via one or more synaptic circuits. A synaptic circuit may include a memory for storing a synaptic weight. One example of this ANN may be a deep neural network having an input layer, an output layer, and a plurality of fully connected hidden layers. In some examples, the ANN (e.g., the control unit 102) can be implemented by an application-specific integrated circuit (ASIC) specially customized for the specific artificial intelligence application described herein and provide superior computing capabilities and reduced electricity consumption compared to traditional computers.

Training data can be generated by receiving continuous data at the control unit 102 and using the control unit 102 to discretize the continuous data. Optionally, the control unit 102 can be trained with a pretrained model. The training data or pretrained model may be received by the control unit 102 remotely over one or more networks. The training data may be historical data, which the neural network can use to learn patterns in the visual representations of the data to identify or detect the same (or similar) patterns in other data collected from other parts or equipment. The trained ANN monitors additional visual representations of data to identify patterns and classify the patterns. If the trained ANN detects one or more patterns, the trained ANN can classify the pattern(s) to generate classification data which can be output to a user and/or used to re-train the ANN.

The ANN of the control unit 102 can continue to learn to improve identification of patterns in data visualizations, as well as improve the classification of the identified patterns. This continued learning can occur by, for example, changing the output generated by one or more of the neurons responsive to receiving the same input (e.g., a neuron produces a different output after the change), changing the activation function of one or more neurons, changing one or more of the weights, and/or changing one or more of the connections between the neurons (or which neurons are connected with each other). Changing one or more of these factors can cause the ANN to produce a different output (e.g., a different pattern is identified and/or a different classification is selected) than prior to the change.

FIG. 10 illustrates a perspective front view of an aircraft 104, according to an example of the present disclosure. The aircraft 104 includes a propulsion system 412 that includes engines 414, for example. Optionally, the propulsion system 412 may include more engines 414 than shown. The engines 414 are carried by wings 416 of the aircraft 104. In other examples, the engines 414 may be carried by a fuselage 418 and/or an empennage 420. The empennage 420 may also support horizontal stabilizers 422 and a vertical stabilizer 424. The fuselage 418 of the aircraft 104 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like. FIG. 10 shows an example of an aircraft 104. It is to be understood that the aircraft 104 can be sized, shaped, and configured differently than shown in FIG. 10. The aircraft 104 can be configured to carry passengers, and/or cargo, for example.

Further, the disclosure comprises examples according to the following clauses:

Clause 1. A system comprising:
a control unit configured to:
   receive wind characteristics for locations at and between a current location of an aircraft and an arrival location, and
   revise a flight plan at one or more of the locations based on the wind characteristics to provide a revised flight plan,
wherein the aircraft is configured to be operated to fly from the current location to the arrival location according to the revised flight plan.

Clause 2. The system of Clause 1, wherein the wind characteristics include wind direction and wind speed.

Clause 3. The system of Clauses 1 or 2, wherein the control unit is onboard the aircraft.

Clause 4. The system of any of Clauses 1-3, further comprising a user interface including a display, wherein the control unit is in communication with the user interface, and wherein the control unit is further configured to show the revised flight plan on the display.

Clause 5. The system of any of Clauses 1-4, wherein the control unit is further configured to automatically control the aircraft according to the revised flight plan.

Clause 6. The system of any of Clauses 1-5, wherein the wind conditions include current and forecasted wind conditions.

Clause 7. The system of any of Clauses 1-6, wherein the control unit is further configured to determine a corridor along the flight plan.

Clause 8. The system of Clause 7, wherein the control unit is further configured to generate a grid including nodes within the corridor.

Clause 9. The system of Clause 8, wherein the control unit is further configured to determine costs between different nodes.

Clause 10. The system of Clause 9, wherein the control unit is further configured to calculate a shortest path having a lowest cost.

Clause 11. The system of Clause 10, wherein the shortest path having the lowest cost is the revised flight plan.

### Clause 12.a Method Comprising:

receiving, by a control unit, wind characteristics for locations at and between a current location of an aircraft and an arrival location;
revising, by the control unit, a flight plan at one or more of the locations based on the wind characteristics to provide a revised flight plan; and
operating the aircraft to fly from the current location to the arrival location according to the revised flight plan.

Clause 13. The method of Clause 12, wherein the wind characteristics include wind direction and wind speed.

Clause 14. The method of Clauses 12 or 13, wherein said operating comprising automatically controlling, by the control unit, the aircraft according to the revised flight plan.

Clause 15. The method of any of Clauses 12-14, further comprising determining, by the control unit, a corridor along the flight plan.

Clause 16. The method of Clause 15, further comprising generating, by the control unit, a grid including nodes within the corridor.

Clause 17. The method of Clause 16, further comprising determining, by the control unit, costs between different nodes.

Clause 18. The method of Clause 17, further comprising calculating, by the control unit, a shortest path having a lowest cost.

Clause 19. The method of Clause 18, wherein the shortest path having the lowest cost is the revised flight plan.

Clause 20. A system comprising:
an aircraft;
a user interface onboard the aircraft, wherein the user interface includes a display; and
a control unit onboard the aircraft, wherein the control unit is in communication with the user interface, the control unit configured to:
   receive wind characteristics for locations at and between a current location of an aircraft and an arrival location, wherein the wind characteristics include wind direction and wind speed,
   determine a corridor along a flight plan for the aircraft between the current location and the arrival location,
   generate a grid including nodes within the corridor,
   determine costs between different nodes,
   calculate a shortest path having a lowest cost,
   revise a flight plan at one or more of the locations based on the wind characteristics to provide a revised flight plan, and
   show the revised flight plan on the display,
wherein the aircraft is configured to be operated to fly from the current location to the arrival location according to the revised flight plan.

As described herein, examples of the present disclosure provide systems and methods for determining a flight plan for an aircraft that reduces fuel consumption. Further, examples of the present disclosure provide systems and methods for determining a flight plan that reduces flight time in headwinds.

The systems and methods described herein facilitate operations along an optimal flight plan, which is optimized to reduce costs (such as fuel consumption and/or time of flight) based on wind characteristics. It has been found that examples of the present disclosure provide significant fuel savings for aircraft, particularly those that fly long haul routes. Additionally, examples of the present disclosure reduce pilot workload by automatically determining optimized flight plans, and can further be configured for automatic operation of aircraft according to such optimized flight plans.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a control unit configured to:
receive wind characteristics for locations at and between a current location of an aircraft and an arrival location, and
revise a flight plan at one or more of the locations based on the wind characteristics to provide a revised flight plan,
wherein the aircraft is configured to be operated to fly from the current location to the arrival location according to the revised flight plan.

2. The system of claim 1, wherein the wind characteristics include wind direction and wind speed.

3. The system of claim 1, wherein the control unit is onboard the aircraft.

4. The system of claim 1, further comprising a user interface including a display, wherein the control unit is in communication with the user interface, and wherein the control unit is further configured to show the revised flight plan on the display.

5. The system of claim 1, wherein the control unit is further configured to automatically control the aircraft according to the revised flight plan.

6. The system of claim 1, wherein the wind conditions include current and forecasted wind conditions.

7. The system of claim 1, wherein the control unit is further configured to determine a corridor along the flight plan.

8. The system of claim 7, wherein the control unit is further configured to generate a grid including nodes within the corridor.

9. The system of claim 8, wherein the control unit is further configured to determine costs between different nodes.

10. The system of claim 9, wherein the control unit is further configured to calculate a shortest path having a lowest cost.

11. The system of claim 10, wherein the shortest path having the lowest cost is the revised flight plan.

12. A method comprising:
receiving, by a control unit, wind characteristics for locations at and between a current location of an aircraft and an arrival location;
revising, by the control unit, a flight plan at one or more of the locations based on the wind characteristics to provide a revised flight plan; and
operating the aircraft to fly from the current location to the arrival location according to the revised flight plan.

13. The method of claim 12, wherein the wind characteristics include wind direction and wind speed.

14. The method of claim 12, wherein said operating comprising automatically controlling, by the control unit, the aircraft according to the revised flight plan.

15. The method of claim 12, further comprising determining, by the control unit, a corridor along the flight plan.

16. The method of claim 15, further comprising generating, by the control unit, a grid including nodes within the corridor.

17. The method of claim 16, further comprising determining, by the control unit, costs between different nodes.

18. The method of claim 17, further comprising calculating, by the control unit, a shortest path having a lowest cost.

19. The method of claim 18, wherein the shortest path having the lowest cost is the revised flight plan.

20. A system comprising:
an aircraft;
a user interface onboard the aircraft, wherein the user interface includes a display; and
a control unit onboard the aircraft, wherein the control unit is in communication with the user interface, the control unit configured to:
receive wind characteristics for locations at and between a current location of an aircraft and an arrival location, wherein the wind characteristics include wind direction and wind speed,
determine a corridor along a flight plan for the aircraft between the current location and the arrival location,
generate a grid including nodes within the corridor,
determine costs between different nodes,
calculate a shortest path having a lowest cost,
revise a flight plan at one or more of the locations based on the wind characteristics to provide a revised flight plan, and
show the revised flight plan on the display,
wherein the aircraft is configured to be operated to fly from the current location to the arrival location according to the revised flight plan.
